(19) United States
(12) Patent Application Publication
(10) Pub. No.: US 2026/0368120 A1
(43) Pub. Date: Nov. 19, 2026

(54) Non-Packetized Electrical Pulse Synchronization

(71) Applicant: Apple Inc., Cupertino, CA (US)

(72) Inventors: Tavys Q Ashcroft, San Jose, CA (US); Chaminda Nalaka Vidanagamachchi, San Jose, CA (US); Dean P Macri, Sherwood, OR (US); Jeffrey J Varga, Renton, WA (US); John K Crooks, Los Angeles, CA (US); Patrick Law, Cupertino, CA (US); Robert K Molholm, Scotts Valley, CA (US); Scott A Jackson, Hampstead, NC (US)

(21) Appl. No.: 19/339,177

(22) Filed: Sep. 24, 2025

Related U.S. Application Data
(60) Provisional application No. 63/806,353, filed on May 15, 2025.

(51) Int. Cl. G06F 13/40; G06F 13/42

(52) U.S. Cl. CPC G06F 13/4054; G06F 13/4291; G06F 2213/0042; G06F 2213/3812

(57) ABSTRACT

Electronic devices may transmit and receive non-packetized electrical pulse signals to communicate timing information. A Universal Serial Bus (USB) Type-C wire may communicatively connect one or more electronic devices. A host device may transmit a data steam of positive non-packetized electrical pulse signals to the electronic devices over the USB Type-C wire. The electronic devices may receive the non-packetized electrical pulse signal and use one or more pulse edges of the data stream to synchronize their respective systems to the timing information of the host device. The electronic devices may also modify the non-packetized positive pulses into synchronization signals to be transmitted to additional logic or circuitry that is associated with particular components or functions of the electronic devices. In some embodiments, the electronic devices may be sequentially connected by wires such that data streams may be provided downstream to enable timing synchronization across the electronic system.

### CROSS-REFERENCE TO RELATED APPLICATIONS

This application claims priority to U.S. Provisional Application No. 63/806,353, filed May 15, 2025, which is incorporated by reference herein in its entirety.

### BACKGROUND

The present disclosure relates generally to electronic device synchronization, and more specifically to timing synchronization among electronic devices in a system.

It is often desirable for electronic devices within a system to perform functions at specified and deterministic time increments. A single system may include many electronic devices. The system may contain many similar electronic devices, different types of electronic devices, different brands or versions of the electronic devices, combinations of similar and dissimilar electronic devices, or the like. These electronic devices may have dedicated functions that are associated with specific processes within the system. Defining when each electronic device performs its designated functions may present challenges. In some instances, it may be desirable for the electronic devices to perform simultaneous operations. In other instances, it may be desirable for the electronic devices to operate at consecutive or otherwise offset time periods. Likewise, it may be desirable for certain sets of electronic devices to perform simultaneous operations while others do not.

Facilitating system operations through the electronic devices may demand that the electronic devices have access to the timing information of other electronic devices in the system. For example, two separate electronic devices may rely on different timing resources. The timing resources may be derived from internal logic or circuitry that informs the timing of the operations of the electronic devices. In some instances, the timing resources may be reference clocks that are aligned with global satellite navigation systems (GNSS), such as Global Positioning System (GPS), Galileo, Indian Regional Navigation Satellite System (NavIC), or the like. However, certain GNSS systems may provide timing information that is offset from one another. Thus, the electronic devices may have unaligned timing resources. Additional factors may also play a role in electronic device timing. For example, the timing resource of a particular electronic device may experience delay or jitter due to certain internal and external conditions (e.g., thermal noise, power supply variations, interference from nearby electronic devices). These variations may also be a cause of the electronic devices operating at offset times. As a result of these offsets, device synchronization may be used across the system to ensure that the electronic devices operate according to a common schedule.

Device synchronization may refer to sharing time information between electronic devices. According to previous designs, electronic devices may synchronize to one another by transmitting timing information that is imbedded in a data format, such as a packet. For example, electronic devices may transmit Precision Time Protocol (PTP) packets to share timing information. PTP synchronization refers to a lead-follower architecture where a leading electronic device sends timestamped PTP packets to a following electronic device. The following electronic device may use the time stamp of the PTP packet to calculate an offset between the time that PTP packet was transmitted and the time that it received the PTP packet. The following electronic device may then adjust its local timing resource (e.g., a local reference clock) to the timing information of the leading electronic device.

Packet-based synchronization may lead to inefficiencies. For example, a consequence of packet-based synchronization is that the reference clock of the leading device may experience inherent delays and jitter. This may result in downstream inaccuracies as the packet timestamps are transmitted to the following electronic device. Further, packet-based synchronization may demand that the following electronic device use computational resources to extract timestamps from the packets, perform calculations on the timestamps to determine an offset, and adjust their own timing resource based on the offset. The following electronic device may continuously adjust its timing resource based on received packets. Thus, packet-based synchronization may specify that the following electronic device reserve computational and hardware resources for maintaining time synchronization by repeatedly adjusting its timing resource. In a system with dozens, hundreds, or any number of electronic devices, the aggregate amount of hardware and computational resources dedicated to time synchronization may have a significant net impact on computational efficiency and timing accuracy.

Alternative techniques for synchronization may suffer from similar deficiencies. For example, video devices may use pulse based synchronization referred to as generator locking (genlock). Genlock may demand specialty hardware, such as a synchronization port, that may not provide alternative functionalities, thus taking up limited resource space in a device. Moreover, genlock may provide limited synchronization as it may only support limited operations (e.g., audio and video synchronization) and may not provide synchronization across the other operations that modern devices may perform. Thus, the specialty hardware that is needed for facilitating pulse based timing synchronization may provide limited benefits in diverse systems where electronic may have varying functions and processes.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a method may include establishing, via processing circuitry of a bridge device, a wired communication session with a host device. The method may also include receiving, via the processing circuitry, a first data stream that includes positive non-packetized electrical pulse signals from the host device via the wired communication session according to a wired communication standard. The method may include generating, via the processing circuitry, a second data stream that includes positive and negative non-packetized electrical pulse signals based on the first data stream. The method may further include transmitting, via the processing circuitry, the second data stream to a first downstream device, where the second data stream is configured to enable the first downstream device to synchronize to the host device.

In another embodiment, an electronic device may include a transmitter and processing circuitry coupled to the transmitter. The processing circuitry may be configured to establish a wired communication session with a transmitting device and establish a communication session with multiple downstream devices. The processing circuitry may also be configured to receive a first data stream from the transmitting device via the wired communication session, where the first data stream includes non-packetized electrical pulses and generate a second data stream that includes non-packetized electrical pulses based on the first data stream. The processing circuitry may cause the transmitter to transmit the second data stream to a first downstream device of the multiple downstream devices, where the second data stream is configured to enable the first downstream device to synchronize to the transmitting device. The processing circuitry may also be configured to generate a third data stream that includes non-packetized electrical pulses based on the first data stream. Additionally, the processing circuitry may be configured to cause the transmitter to transmit the third data stream to a second downstream device of the multiple downstream devices, where the third data stream is configured to enable the second downstream device to synchronize to the transmitting device.

In yet another embodiment, an electronic device may include an input/output (I/O) interface and processing circuitry coupled to the IO interface. The processing circuitry may be configured to cause the electronic device to receive, via the I/O interface, a first data stream that includes positive non-packetized electrical pulse signals from a first device. The processing circuitry may be configured to generate a second data stream that includes non-packetized electrical pulse signals based on the first data stream and transmit the second data stream to a second device, where the second data stream is configured to enable the second device to synchronize to the first device. The processing circuitry may also be configured to generate a third data stream that includes non-packetized electrical pulse signals based on the first data stream and transmit the third data stream to a third device, where the third data stream is configured to enable the third device to synchronize to the first device.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a block diagram of a synchronization connection between client and host devices in the form of the electronic devices of FIG. 1 via a coupling , according to embodiments of the present disclosure ;

FIG. 3 is a block diagram of another embodiment of the synchronization connection between the electronic devices of FIG. 2 , according to embodiments of the present disclosure ;

FIG. 4 is a schematic diagram of a Universal Serial Bus (USB) Type-C port that may be included in the client device, the host device, and the coupling that are depicted in FIGS. 2 and 3 , according to embodiments of the present disclosure;

FIG. 5 is a flowchart of a method for the client device of FIGS. 2 and 3 to synchronize to timing information of the host device of FIGS. 2 and 3, according to embodiments of the present disclosure;

FIG. 6 is a flowchart of another method for the client device of FIGS. 2 and 3 to synchronize to timing information of the host device of FIGS. 2 and 3, according to embodiments of the present disclosure;

FIG. 7 is a flowchart of a method for the client device of FIGS. 2 and 3 to receive timing information from the host device of FIGS. 2 and 3 and generate an additional data stream that may provide timing information to downstream devices, according to embodiments of the present disclosure; and

FIG. 8 is a block diagram demonstrating time synchronization in a system that includes downstream devices according to the method described with reference to FIG. 7.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 % of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to timing synchronization in a system that includes electronic devices. More specifically, electronic devices may communicate using non-packetized electrical pulse signals, which may be used by the electronic devices to share and synchronize timing information. As used herein, a system may refer to any communicative coupling of at least two electronic devices. In an embodiment, a system may include a host device that is communicatively coupled with a client device via a cable or wires. For example, a Universal Serial Bus (USB) Type-C cable may communicatively connect the host device to the client device. The host device may transmit positive non-packetized electrical pulse signals (e.g., electrical pulse signals that may include voltages greater than or equal to zero) to the client device. The client device may receive the non-packetized electrical pulse signals and use them to synchronize internal logic or circuitry to the timing of the host device. That is, the client device may use one or more pulse edges of the data stream of non-packetized electrical pulses to synchronize its system timing information to the timing information of the host device. I t is initially worth noting that synchronization may not specify that the host device and the client device operate concurrently. Rather, synchronization may refer to the host device and the client device operating according to a unified time domain such that each may operate at deterministic time increments. With that in mind, in some embodiments, the client device may convert the non-packetized positive pulses into positive and negative digital signals to be transmitted to additional logic or circuitry of a particular component (e.g., a display, a camera, a strobe or lighting element) of the client device. For example, in some embodiments, the receiving electronic devices may use the received non-packet electrical pulse signals as system timing information and for specified component synchronization.

In some embodiments, the host device may be communicatively coupled to multiple client devices. The host device may transmit the non-packetized electrical pulse signals to each of the client devices to which it is communicatively coupled. Likewise, in some embodiments, the client devices may be sequentially coupled to downstream electronic devices. The downstream electronic devices may include any electronic devices that are communicatively coupled (e.g., wired or wirelessly) to the client devices. The client devices may receive the non-packetized electrical pulse signals from the host device, use those signals to synchronize their internal logic or circuitry (e.g., their system timing information), and/or generate a data stream of non-packetized electrical pulse signal to transmit to the downstream devices. This process may be repeated at various levels of downstream connection (e.g., a downstream electronic device that is five or more connections from the host device, a downstream electronic device that is twenty or more connections from the host device). In these ways, each electronic device in the system, including the host device, the client devices, and the downstream device, may be synchronized to the host device based on data streams of non-packetized electrical pulse signals. Resultingly, all of the electronic devices may be communicatively coupled such that they may operate according to a unified timing domain.

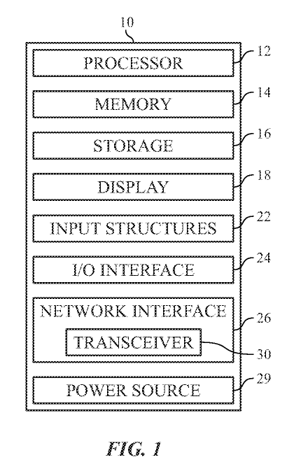

With this in mind, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, Long Term Evolution (LTE) cellular network, Long Term Evolution License Assisted Access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB‐H) network, ultra-wideband (UWB) network, alternating current (AC) power lines, and so forth.

As illustrated, the network interface 26 may include a transceiver or modem 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter.

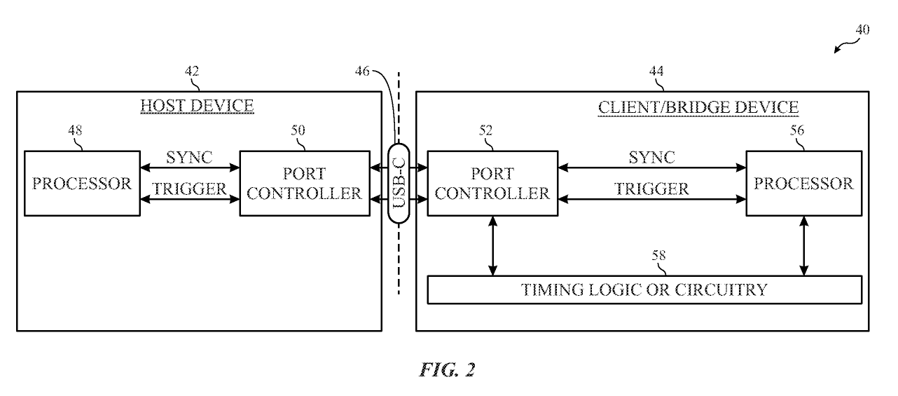

FIG. 2 is a block diagram 40 of a synchronization connection between two electronic devices. In this diagram 40, a host device 42 acts as a time leader for a client/bridge device 44, which may be a time follower. The time leader may provide timing information to the time follower. For example, the time leader may provide synchronization signals to the time follower. The time follower may receive the synchronization signals and use the synchronization signals to synchronize internal hardware (e.g., logic or circuitry associated with system timing) to the time leader. As discussed in more detail herein, the host device 42 and the client/bridge device 44 may include electronic devices (e.g., the electronic device 10 of FIG. 1) that include the same components, similar components, or different components. For example, the host device 42 and the client/bridge device 44 may both be in the form of the electronic device 10 of FIG. 1. With that in mind, the host device 42 and the client/bridge device 44 may be communicatively coupled via a cable 46. In this example, the cable 46 includes a Universal Serial Bus (USB) Type-C cable 46. The host device 42 may have various hardware components associated with timing synchronization. For example, the host device 42 may include a processor 48. The processor 48 may include logic or circuitry, such as one or more sensors, that may be configured to respond to inputs and generate outputs. The processor 48 may be in the form of the processor 12 as discussed above. For example, the processor 48 may be configured to generate a data stream of non-packetized electrical pulse signals. The electrical pulse signals may include any digital or analog signals that characterize an electronic charge. The electrical pulse signals may be non-packetized such that electrical pulse signals may indicate synchronization points as a stream of bits rather than in discrete packets. The data stream of non-packetized electrical pulse signals may contain many electrical pulse signals having different amplitudes and frequencies. The host device 42 may transmit the data streams of non-packetized electrical pulse signals across a port controller 50. The port controller 50 may include an input/output interface (e.g., the I/O interface 24 of FIG. 1) that is configured to facilitate wired communications with the client/bridge device 44. The port controller 50 may facilitate receiving and processing input data streams and transmitting output data streams. By way of example, in a USB Type-C connection, the port controller 50 may receive Vendor-Defined Messages (VDMs) during a USB Power Delivery (USB PD) handshake to determine a USB mode in which to operate. For example, the host device 42 and the client/bridge device 44 may exchange VDMs indicating an agreement to enter the synchronization mode described herein.

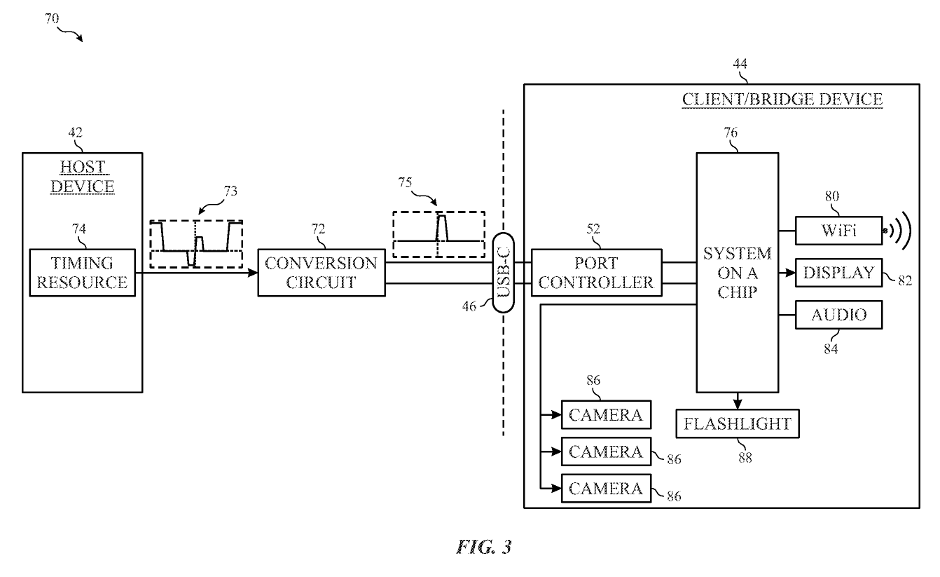

The client/bridge device 44 may include similar hardware components for facilitating electronic communications. For example, the client/bridge device 44 may also include a port controller 52. The client/bridge device 44 may receive a data stream of non-packetized electrical signals over the USB Type-C cable 46 at the port controller 52 from the host device 42. In this manner, the port controller 52 of the client/bridge device 44 may perform similar functions to the port controller 50 of the host device 42. In some embodiments, the port controller 52 may use a general purpose input/output (GPIO) pin to transmit the data stream of non-packetized electrical signals to intermediate logic or circuitry that may filter or amplify voltages of received and transmitted signals. The intermediate logic or circuitry may be included at various places within the client device. For example, the intermediate logic or circuitry may be coupled between the port controller 52 and processor 56, the port controller 52 and timing logic or circuitry 58, and/or the processor 56 and the timing logic or circuitry 58. In additional embodiments, the intermediate logic or circuitry that may filter or amplify voltages may also be included in the processor 56. The intermediate logic or circuitry may, therefore, allow the client/bridge device 44 to receive data streams of non-packetized electrical pulse signals from the host device 42 that include different amplitudes, frequencies, and the like, and, in some embodiments, compensate for any differences. For example, the processor 56 and/or internal logic or circuitry 58 of the client/bridge device 44 may have hardware thresholds related to the voltage level (e.g., 3 volts) of electrical signals that they may receive and process, the client/bridge device 44 may receive a data stream of non-packetized electrical pulse signals that include electrical signals of a higher voltage (e.g., 5 volts) and use the intermediate logic or circuitry to filter those signals to the thresholds voltage level of the client/bridge device 44. The client device may also include timing logic or circuitry 58, which may control the timing of the client/bridge device 44. For example, the timing logic or circuitry 58 may refer to a system clock (e.g., a reference clock for the client/bridge device 44). As discussed in FIG. 3, the client/bridge device 44 may also include timing logic or circuitry 58 that is associated with a particular component of the client/bridge device 44. By way of example, in embodiments where the client/bridge device 44 is a smartphone, the timing logic or circuitry 58 may refer to a system clock associated that is associated with the smartphone; or the timing logic or circuitry 58 may be associated with a particular component of the smartphone, such as a front camera, a rear camera, a display, a lighting device (e.g., a strobe), a speaker, an inertial measurement unit (IMU), or the like.

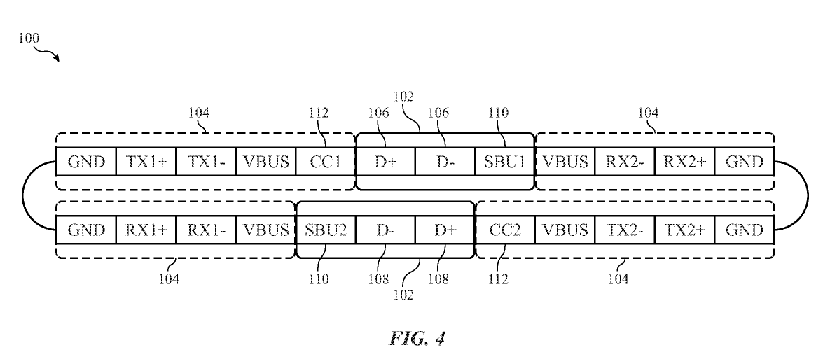

FIG. 3 is a block diagram 70 of another embodiment of the synchronization connection between the host device 42 and the client/bridge device 44 that are depicted in FIG. 2. In this embodiment, the USB connection 46 may include a USB Typer-C connection 46 that is assisted by a conversion circuit 72. The conversion circuit 72 may include a hardware component that is an intermediary between the host device 42 and the client/bridge device 44. For example, the conversion circuit 72 may include a USB Type-C adapter, a captive cable, a dongle, or another suitable breakout accessory. The conversion circuit 72 may provide a USB connection 46 interface to supplement either the host device 42 or the client/bridge device 44 by enabling USB connectivity for electronic devices that may not include USB ports. For example, if the host device 42 does not have USB hardware (e.g., a USB port as depicted in FIG. 4) then the conversion circuit 72 may be used to facilitate the USB connection 46 between the host device 42 and the client/bridge device 44. As described with respect to FIG. 2, the host device 42 and the client/bridge device 44 may be in the form of the electronic device 10 of FIG. 1, and thus have various hardware components, such as processors, sensors, and/or port controllers to facilitate electronic communications among the two devices 42, 44. In this example, the host device 42 includes a timing resource 74. The timing resource 74 may include logic, circuitry, or other hardware (e.g., a reference clock) or software that may generate timing information and/or control system timing within the host device 42. For example, the timing resource 74 may include a Global Positioning System/Global Navigation Satellite System (GPS/GNSS) synchronizer to provide the host device 42 with timing information. The host device 42 may share the timing information derived from the timing resource 74 with the client/bridge device 44 across the conversion circuit 72 and the USB Type-C connection 46.

In some embodiments, the host device 42 may transmit timing information as electrical signals that may include positive and negative electrical pulses. For example, the host device 42 may send genlock or tri-level synchronization signals to the client/bridge device 44. However, according to current standards, USB connections 46 may accept positive electrical pulses and not negative electrical pulses. Thus, the conversion circuit 72 may convert the positive and negative electrical pulse signals 73 that are transmitted by the host device 42 to a USB-compatible data stream of positive non-packetized electrical pulse signals 75. The conversion circuit 72 may convert the positive and negative electrical pulses 73 into the data stream of positive non-packetized electrical pulse signals 75 based on pulse edge-based signal conversion. The positive non-packetized electrical pulse signals may be transmitted to the client/bridge device 44 over the USB connection 46.

The client/bridge device 44 may have various hardware components for receiving and using the positive non-packetized electrical pulse signals. For example, the client/bridge device 44 may include the port controller 52 that is described with reference to FIG. 2. The port controller 52 may use a GPIO pin to transmit the received positive non-packetized electrical pulse signals to additional components of the client/bridge device 44, such as a System on a Chip (SOC) 76. The SOC may include a microchip integrating various hardware components of the client/bridge device 44, such as a central processing unit (CPU), a graphics processing unit (GPU), memory interfaces, input/output devices, transceivers, and the like. For purposes of this discussion, the SOC 76 may correspond to the processor 56 of the client/bridge device 44 described with reference to FIG. 2. The SOC 76 may also include logic or circuitry that may generate multiple synchronization signals. For example, the SOC 76 may receive the data stream of positive non-packetized electrical pulse signals 75 and use the data stream to generate multiple synchronization signals. In some embodiments, positive non-packetized electric pulse signal 75 may refer to electrical pulse signals with positive voltages (e.g., voltages greater than zero) and neutral voltages (e.g., voltages equal to zero). In these embodiments, the SOC 76 may generate the synchronization signals based on a pulse edge of the data stream of positive non-packetized electrical pulse signals 75 that indicates a transition from a neutral voltage to a positive voltage or from a positive voltage to a neutral voltage. Likewise, in other embodiments, the SOC 76 may generate the synchronization signals based on the voltage level of only positive electrical pulses (e.g., a difference in amplitudes of consecutive pulses) in the data stream of non-packetized electrical pulse signals 75. These example embodiments are intended to demonstrate that the SOC 76 may generate the synchronization signals based on characteristics extracted from various types of data streams of non-packetized electrical pulse signals 75.

The SOC 76 may transmit the synchronization signals to components of the client/bridge device 44. Thus, the logic or circuitry for generating multiple synchronization signals may be useful because various components of the client/bridge device 44 may be associated with independent operational and timing systems. In some embodiments, the synchronization signals may be used to cause the various components of the client/bridge device 44 to perform respective actions simultaneously or consecutively. For example, the SOC 76 may transmit a synchronization signal to a Wi-Fi module 80, a display 82, and/or an audio component 84 (e.g., an asynchronous sample rate converter (ASRC)). The SOC 76 may transmit another synchronization signal or set of synchronization signals to intermediate logic or circuitry that may act as a voltage level shifter to adjust an amplitude of the synchronization signals. As described with reference to FIG. 2, the intermediate logic or circuitry may be configured to amplify or filter one or more synchronization signals before it is provided to a hardware component of the client/bridge device 44. In some embodiments, the synchronization signals may be filtered by the intermediate logic or circuitry before the synchronization signal is provided to a component of the client/bridge device 44 (e.g., the one or more cameras 86). Similarly, the multiple synchronization signals may be provided to any other component of the client/bridge device 44 that utilizes timing information. For example, in this diagram 70, the SOC 76 may also generate a synchronization signal for a flashlight 88 or a strobe (e.g., a light that may be flashed, sometimes in a rapid pattern to generate a blinking and/or pulsing effect, that may be used for visual effects). In these ways, the SOC 76 may be viewed as the system timing resource for the client/bridge device 44. The SOC 76 may be synchronized to the timing resource 74 of the host devices 42 and, resultingly, the SOC 76 may generate synchronization signals for specific components of the client/bridge device 44 to synchronize those components to the timing resource 74 of the host device 42.

The logic or circuitry of the SOC 76 that may enable it to generate multiple synchronization signals may provide benefits in systems where electronic devices or components that interact with one another. By way of example, in a virtual production system the host device 42 may include a display, such as a smart (television) TV. The client/bridge device 44 may include a recording device that includes an audio component 84 and a camera 86. The client/bridge device 44 may be tasked with recording the host device 42 and its surrounding environment. Therefore, it may be desirable to synchronize a capture rate of the camera 86 with the display rate of the host device 42. Likewise, it may be desirable to synchronize the capture rate of the camera 86 to a recording rate of the audio component 84. The host device 42 may send timing information in the form of a data stream of non-packetized electrical pulse signals 75 to the client/bridge device 44. The SOC 76 of the client/bridge device 44 may receive the data stream of non-packetized electrical pulse signals and generate synchronization signals to provide to internal logic or circuitry associated with the camera 86 and additional synchronization signals to provide to internal logic or circuitry associated with the audio component 84. Resultingly, all three functions of the virtual production system (e.g., display, camera capturing, and audio recording) may be synchronized as part of a cohesive virtual production experience.

FIG. 4 is a schematic diagram 100 of a USB Type-C port that may be included in the client/bridge device 44, the host device 42, and/or conversion circuit 72 that are depicted in FIGS. 2 and 3. The USB Type-C port may include various pairs of pins or terminals that are associated with different functions during a communication session. Although various pins are depicted, only some of the depicted pins may be relevant to the discussion of this disclosure. A first set of pins (hereinafter referred to as “synchronization pins”) 102 may be used for the synchronization techniques discussed herein. A second set of pins (hereinafter referred to as “reserved pins”) 104 may be reserved for other USB functions and may not be used for the synchronization techniques discussed herein.

The synchronization pins 102 may include top pair USB pins 106, bottom pair USB pins 108, and sideband pins 110. The top pair USB pins 106 (also referred to as mission USB pins or standard pair USB pins), the bottom pair USB pins 108 (also referred to a debug USB pins or alternate pair USB pins), and the sideband USB pins 110 may be available for use in USB alternate modes for functions such as the synchronization technique disclosed herein. That is, the synchronization pins 102 may be used to transmit and receive data, including data streams of positive non-packetized electrical pulse signals.

The type of USB connection between electronic devices (e.g., the host device 42 and the client/bridge device 44) may define which pair of USB pins are available for synchronization. In particular, the type of USB cable that is used to facilitate the communication session between the electronic devices may enable certain pins to be used for synchronization while preventing other pins from being used for synchronization. For example, if two electronic devices are connected via a USB 2.0 Type-C cable, then the top pair USB pins 106 may be used for synchronization. If the two electronic devices are connected via a USB Full Feature Type-C cable, then the sideband pins 110 may be used for synchronization. Further, if the two electronic devices are connected via a conversion circuit (e.g., the conversion circuit 72 in FIG. 3), such as a captive cable, then the top pair USB pins 106, the bottom pair USB pins 108, or the sideband pins 110 may be used for synchronization.

A pair of configuration pins 112 may be part of the reserved pins 104 that are not used to receive and transmit synchronization signals. However, the configuration pins 112 may provide useful indications regarding an intended mode of the USB communication. USB communication may be used for many tasks such as power delivery and file sharing. To facilitate the alternate synchronization mode described herein, the electronic devices may share a USB Power Delivery (USB PD) handshake at the time that the two electronic devices are connected. The USB PD handshake may enable the electronic devices to share vendor-defined messages (VDMs) for entering the synchronization mode described herein.

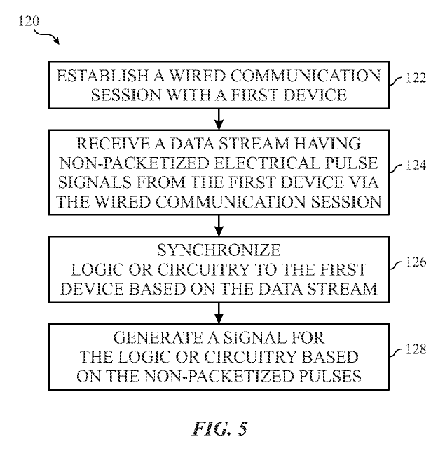

With the foregoing in mind, FIG. 5 is a flowchart of a method 120 for the electronic device 10 (e.g., the client/bridge device 44 of FIGS. 2 and 3) to synchronize to the timing information of a first device (e.g., the host device 42 of FIGS. 2 and 3), according to embodiments of the present disclosure. Any suitable device (e.g., a controller) that may control components of the electronic device 10, such as the processor 12 (e.g., the processor 56 in FIG. 2 and the SOC 76 in FIG. 3), may perform the method 120. In some embodiments, the method 120 may be implemented by executing instructions stored in a tangible, non-transitory, computer-readable medium, such as the memory 14 or storage 16, using the processor 12. For example, the method 120 may be performed at least in part by one or more software components, such as an operating system of the electronic device 10, one or more software applications of the electronic device 10, and the like. While the method 120 is described using steps in a specific sequence, it should be understood that the present disclosure contemplates that the described steps may be performed in different sequences than the sequence illustrated, and certain described steps may be skipped or not performed altogether.

At process block 122, the processor 56 of the client/bridge device 44 may establish a wired communication session with a host device 42. The processor 56 of the client/bridge device 44 may establish the communication session with the host device 42 via a cable 46. For example, the client/bridge device 44 may be communicatively coupled to the host device 42 by a USB connection that is facilitated by a USB Type-C cable 46. The processor 56 may initiate the communication session by initializing a USB PD handshake. For example, the processor 56 and the host device 42 may agree to communicate in a USB alternate mode associated with synchronization at the start of the communication session. In other embodiments, the processor 56 may enter the USB alternate mode associated with synchronization subsequent to its initial connection with the host device 42.

At process block 124, the processor 56 of the client/bridge device 44 may receive a data stream that includes non-packetized electrical pulse signals (e.g., the data stream of non-packetized electrical pulse signals 75 in FIG. 3) from the host device 42. The data stream may include only positive, and not negative, non-packetized electrical pulse signals. In other embodiments, the data stream may include only negative, and not positive, non-packetized electrical signals. That is, the data stream may include bi-level synchronization signals. Bi-level synchronization signals may refer to a synchronization signal that may include a low value (e.g., zero voltage or negative voltage) and a high value (e.g., a positive voltage or a zero voltage). The data stream may include varying increments of non-packetized electrical pulse signals. That is, in some embodiments, the data stream may include pulse signals that are approximately consistently or regularly spaced (e.g., by seconds, microseconds, nanoseconds). In other embodiments the data stream may include non-packetized electrical pulse signals at varying spaces (e.g., 10 nanoseconds between a first pulse signal and a second pulse signal followed by 20 nanoseconds between the second pulse signal and a third pulse signal). In these ways, the processor 56 may use the data stream of electrical non-packetized electrical pulse signals broadly to synchronize a system clock and more specifically to trigger a process of the client/bridge device 44, such as a display rate or frame capture rate.

At process block 126, the processor 56 may synchronize timing of logic or circuitry (e.g., the timing logic or circuitry 58 in FIG. 2) of the client/bridge device 44 to the timing information of the host device 42 based on the data stream of non-packetized electrical pulse signals. That is, the processor 56 may extract timing information from the data stream of non-packetized electrical pulse signals. For example, at the start of synchronization, the processor 56 may receive a first non-packetized electrical pulse signal. Because electrical pulse signals may be transmitted across a cable at high speeds (e.g., nearing the speed of light), the processor 56 may synchronize timing of the logic or circuitry of the client/bridge device 44 to a time domain of the host device 42 based on the first pulse signal. The processor 56 may receive subsequent electrical pulse signals in the data stream of non-packetized electrical pulse signals and use the subsequent electrical pulse signals to refine or reset the timing of the logic or circuitry. In this way, the processor 56 may synchronize the timing or circuitry of the client/bridge device 44 to the host device 42 based on electrical pulse signals rather than repeatedly having to receive and calculate offsets associated with time stamped packets.

At process block 128, the processor 56 may generate a signal for the logic or circuitry based on the data stream of non-packetized electrical pulses. That is, the processor 56 may generate one or more synchronization signal for the logic or circuitry based on the non-packetized electrical pulse signals. For example, the processor 56 may include logic or circuitry for generating multiple synchronization signals (e.g., as described with reference to the SOC 76 in FIG. 3) may receive the data stream of non-packetized electrical pulses and extract synchronization signals to be transmitted to specified logic or circuitry within the client/bridge device 44. As described with reference to FIGS. 2 and 3, this may be useful if the client/bridge device 44 includes multiple components that may operate according to timing information. By way of example, the processor 56, may generate a synchronization signal to be transmitted to a particular component of the client/bridge device 44. Resultingly, the particular component may be synchronized to the host device 42.

In some embodiments, at process block 128, the processor 56 may generate the signal for the logic or circuitry based on the data stream of non-packetized electrical pulses and an offset. In determining the offset to apply to the client/bridge device 44, the processor 56 may evaluate the amount of time that it takes the client/bridge device 44 to perform certain operations. By way of example, if the client/bridge device 44 is synchronized to the host device 42 for video recording, the processor 56 may determine an offset associated with the amount of time that it takes for a camera (e.g., the camera 86 of FIG. 3) of the client/bridge device 44 to capture a single frame (e.g., one millisecond). The data stream of non-packetized electrical pulse signals may include pulse signals at designated increments associated with a frame rate of the host device 42. The processor 56 of the client/bridge device 44 may account for the offset by adjusting the synchronization signal according to the time that the camera takes to capture a single frame. That is, the synchronization signal that the processor 56 generates at process block 128 may be shifted from the time that the client/bridge device 44 receives the data stream of non-packetized electrical pulse signals from the host device 42. In this way, the client/bridge device 44 may perform operations at a deterministic time that is synchronized to the host device 42.

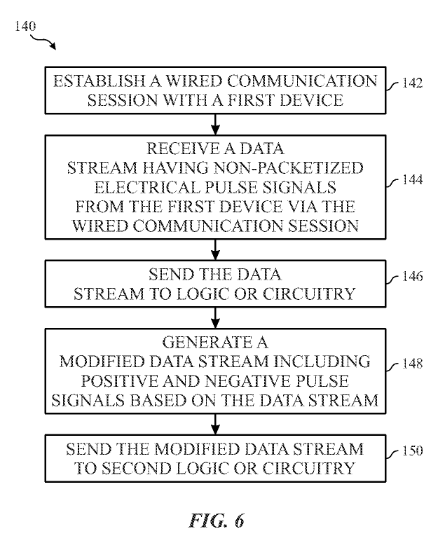

FIG. 6 is a flowchart of another method 140 for the electronic device 10 (e.g., the client/bridge device 44 of FIGS. 2 and 3) to synchronize to the timing information of a first device (e.g., the host device 42 of FIGS. 2 and 3), according to embodiments of the present disclosure. Any suitable device (e.g., a controller) that may control components of the electronic device 10, such as the processor 12(e.g., the processor 56 in FIG. 2 and the SOC 76 in FIG. 3), may perform the method 140. In some embodiments, the method 140 may be implemented by executing instructions stored in a tangible, non-transitory, computer-readable medium, such as the memory 14 or storage 16, using the processor 12. For example, the method 140 may be performed at least in part by one or more software components, such as an operating system of the electronic device 10, one or more software applications of the electronic device 10, and the like. While the method 140 is described using steps in a specific sequence, it should be understood that the present disclosure contemplates that the described steps may be performed in different sequences than the sequence illustrated, and certain described steps may be skipped or not performed altogether.

Process blocks 142-146 correspond to processor blocks 122-126 in FIG. 5. For sake of brevity, the method 140 may proceed regarding process blocks 142-146 as described with respect to process blocks 122-126 in FIG. 5.

At process block 148, the processor 56 may generate a modified data stream that includes positive and negative electrical pulse signals. The processor 56 may generate the modified data stream based on pulse edge inputs of the data stream of non-packetized electrical pulse signals. In some embodiments, for example, the modified data stream may include a bi-level synchronization data stream or tri-level synchronization data stream for use in video applications, such as genlock. Bi-level synchronization may refer to a synchronization signal that may include a low value (e.g., zero voltage or negative voltage) and a high value (e.g., a positive voltage or zero voltage). Tri-level synchronization may refer to a synchronization signal that may include a low value (e.g., a negative voltage), a middle value (e.g., zero voltage), and a high value (e.g., a positive voltage). In other embodiments, the modified data stream may be different signals, for example direct current (DC) or alternating current (AC) signals, that may be used in video recording or by other components of the client/bridge device 44 for operations that may not be associated with video recording.

At process block 150, the processor may send the modified data stream to second logic or circuitry. The second logic or circuitry may refer to logic or circuitry within the client/bridge device 44. For example, the second logic or circuitry may control a particular component (e.g., the audio component 84 of FIG. 3, the flashlight 88 of FIG. 3) of the client/bridge device 44. Alternatively, the second logic or circuitry may refer to logic or circuitry that is external to the client/bridge device 44. For example, the second logic or circuitry may be transmitted to an auxiliary or external device that is communicatively coupled to the client/bridge device 44 via one or more wires or wirelessly. In this manner, the client/bridge device 44 may use the data stream of non-packetized electrical pulse signals for timing synchronization and for use in other operations.

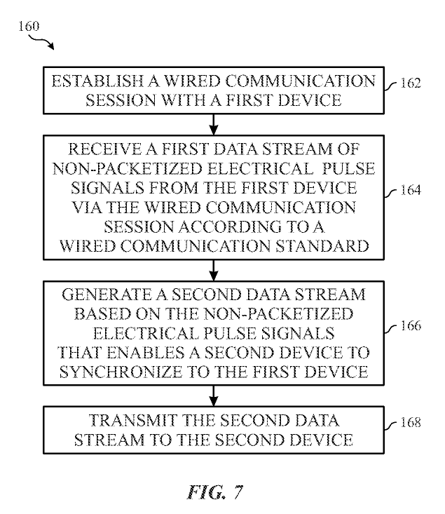

FIG. 7 is a flowchart of a method 160 for the electronic device 10 (e.g., the client/bridge device 44) to receive a data stream of non-packetized electrical pulse signals from a first electronic device (e.g., the host device 42) and generate a data stream of non-packetized electrical pulse signals for a second electronic device, according to embodiments of the present disclosure. Any suitable device (e.g., a controller) that may control components of the electronic device 10, such as the processor 12 (e.g., the processor 56 in FIG. 2 and the SOC 76 in FIG. 3), may perform the method 160. In some embodiments, the method 160 may be implemented by executing instructions stored in a tangible, non-transitory, computer-readable medium, such as the memory 14 or storage 16, using the processor 12. For example, the method 160 may be performed at least in part by one or more software components, such as an operating system of the electronic device 10, one or more software applications of the electronic device 10, and the like. While the method 160 is described using steps in a specific sequence, it should be understood that the present disclosure contemplates that the described steps may be performed in different sequences than the sequence illustrated, and certain described steps may be skipped or not performed altogether.

At process block 162, the processor 56 of the client/bridge device 44 may establish a wired communication session with the host device 42. The processor 56 may connect to the host device via a cable, such a USB Type-C cable 46. The client/bridge device 44 and the host device 42 may engage in an alternate mode of USB communication by sharing VDMs during a USB PD handshake. Thus, the client/bridge device 44 and the host device 42 may be communicatively coupled such that they may transmit and/or receive data from one another.

At process block 164, the processor 56 of the client device 10 may receive a first data stream of non-packetized electrical pulse signals from the host device 42 via the wired communication session according to a wired communication standard. The client/bridge device 44 and the host device 42 may be communicatively coupled using a USB alternate mode. The client/bridge device 44 may receive the first data stream from the host device 42 and, in some embodiments, the processor 56 may use the first data stream to synchronize the logic or circuitry of the client/bridge device 44 to the host device 42 (e.g., process blocks 126 and 128 in FIG. 5). For example, the client/bridge device 44 may perform an action (e.g., updating a display) based on the first data stream. Additionally, as described below, the client/bridge device 44 may use the received data stream of non-packetized digital pulse signals for downstream synchronization.

At process block 166, the processor 56 may generate a second data stream of non-packetized digital pulse signals for transmission to a second electronic device (hereinafter referred to as a “downstream device”). The processor 56 may generate the second data stream of non-packetized electrical pulse signals based on the first data stream of non-packetized electrical pulse signals. In some embodiments, the processor 56 may account for timing delays. For example, in most cases, the transmission time associated with transmitting and receiving the data stream of non-packetized electrical pulse signals may be negligible. However, in certain instances internal and/or external factors may lead to delays in signal processing. The processor 56 may account for any processing delays and adjust the second data stream of non-packetized electrical pulse signals by offsetting the data stream of non-packetized electrical pulse signals by the processing delays.

At process block 168, the processor 56 may transmit the second data stream to the downstream device. The downstream device may include a downstream device that is communicatively coupled (e.g., via a USB Type-C wire) to the electronic device. The client device may be communicatively coupled to the downstream device by a cable, such as a USB cable. In other embodiments, the client/bridge device 44 may be communicatively coupled to the downstream devices via another type of cable, such as an Ethernet cable, a High-Definition Multimedia Interface (HDMI) cable, a fiber optic cable, or the like. Further, in some embodiments, the client/bridge device 44 may be communicatively coupled to the downstream device wirelessly (e.g., by Bluetooth, Wi-Fi). That is, the client/bridge device 44 may be coupled to the host device 42 over a first USB connection and the client/bridge device 44 may be coupled to the downstream device over a second connection. The downstream device may receive the second data stream and use the non-packetized electrical pulse signals to synchronize to the timing information of the host device 42. In this way, the client/bridge device 44 and the downstream device may both be synchronized to the timing of the host device 42. Although this example describes just one client/bridge device 44 and one downstream device, it is envisaged that the disclosed techniques could be used to in a system containing any number of client and downstream devices. In this manner, the method 160 enables timing synchronization among many electronic devices in a system.

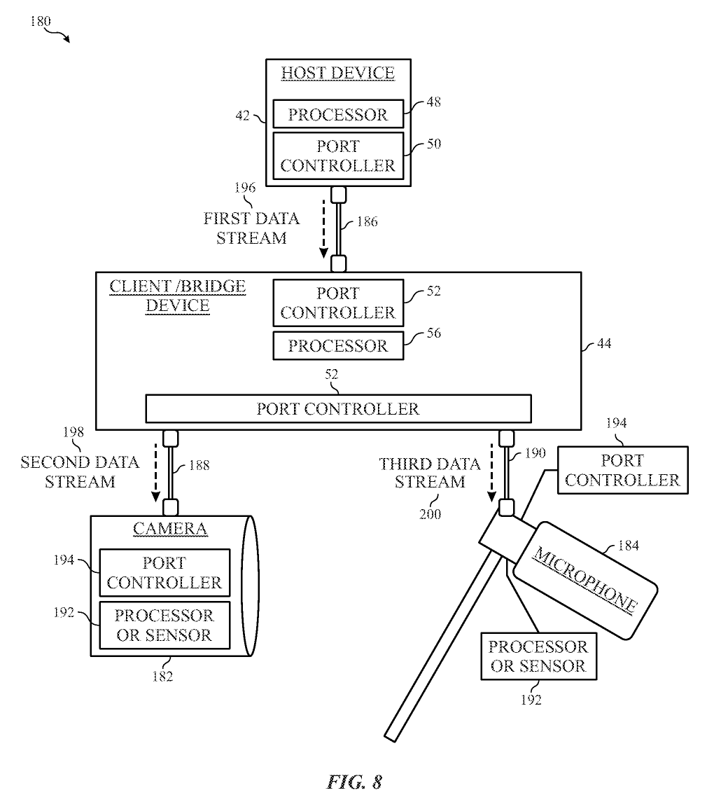

FIG. 8 provides an example diagram 180 of sequential time synchronization in a system in accordance with the method 160 described with reference to FIG. 7. The system includes a host device 42, a client/bridge device 44, a camera 182, and a microphone 184 that are communicatively coupled by cables. The host device may be communicatively coupled to the client device via a first cable 186 (e.g., the USB Type-C cable 46 of FIG. 2). The client/bridge device 44 may be communicatively coupled to the camera 182 by a second cable 188 and the microphone 184 by a third cable 190. The second cable 188 and the third cable 190 may be any suitable cables (e.g., an Ethernet cable, a fiber optics cable) that enable the client/bridge device 44 to communicate with the camera 182 and the microphone 184. In some embodiments, either or both of the camera 182 and the microphone 184 may be communicatively coupled to the client/bridge device 44 wirelessly. In this manner, the camera 182 and the microphone 184 may be downstream devices that are communicatively coupled to the client/bridge device 44 without being communicatively coupled to the host device 42. As described above, the host device 42 and the client/bridge device 44 may have processors 48, 56 and port controllers 50, 52. Likewise, the camera 182 and the microphone may have processors or sensors 192 and port controllers 194 to enable them to receive input signals from the client/bridge device 44.

In this depiction, the host device 42 sends a first data stream 196 of non-packetized electrical pulse signals to the client/bridge device 44. The client/bridge device 44 may receive the first data stream 196 at the port control 52. In some embodiments, the client/bridge device 44 may synchronize internal logic or circuitry to the first data stream 196 of non-packetized electrical pulse signals. The client/bridge device 44 may also use the data stream of non-packetized electrical pulse signals to communicate with downstream devices (e.g., the camera 182 and the microphone 184). For example, the client/bridge device 44 may generate a second data stream 198 of non-packetized electrical pulse signals based on the first data stream 196 and transmit the second data stream 198 to the camera 182. Similarly, the client/bridge device 44 may generate a third data stream 200 of non-packetized electrical pulse signals based on the first data stream 196 of non-packetized electrical pulse signals and transmit the second data stream 198 to the camera 182 and the microphone 184. In some embodiments, the second data stream 198 and/or the third data stream 200 may include positive and negative electrical pulses (e.g., process block 148 in FIG. 6).

In some embodiments, the timing leader may change. USB-Type C communications may be bidirectional. Thus, any electronic device in the system may be designated as the time leader for the system. For example, in this diagram, the client/bridge device 44 may become the time leader and transmit data streams of non-packetized electrical pulse signals to the host device 42, the camera 182, and the microphone 184. That is, the host device 42 may be a time leader at a first time, and a time follower at a second, subsequent time. Likewise, the client/bridge device 44 may be a time follower at the first time and a time leader at the second time. For example, in some situations, the client/bridge device 44 may receive a data stream of non-packetized pulses from one of the downstream devices (e.g., the camera 182 or the microphone 186), which may become a time leader. The client/bridge device may use the data stream received from the downstream device to generate additional data streams to synchronize internal components and/or the host device 42 to the downstream device. The ability to change the time leader may provide useful benefits. For example, if the timing leader (e.g., the host device 42) is disconnected from the client/bridge device 44, the system may automatically designate the client/bridge device 44 as the subsequent time leader. This may prevent desynchronization or timing delays between the electronic devices that remain connected (e.g., the camera 182 and the microphone 184) in the system.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method comprising:
establishing, via processing circuitry of a bridge device, a wired communication session with a host device;
receiving, via the processing circuitry, a first data stream comprising positive non-packetized electrical pulse signals from the host device via the wired communication session according to a wired communication standard;
generating, via the processing circuitry, a second data stream comprising positive and negative non-packetized electrical pulse signals based on the first data stream; and
transmitting, via the processing circuitry, the second data stream to a first downstream device, wherein the second data stream is configured to enable the first downstream device to synchronize to the host device.

2. The method of claim 1, wherein the wired communication standard is a Universal Serial Bus (USB) Type-C alternate mode.

3. The method of claim 1, wherein the wired communication session is established according to a USB cable comprising a USB Full Featured Type-C cable, a USB 2.0 Type-C cable, or a USB Type-C captive cable.

4. The method of claim 3, comprising selecting, via the processing circuitry, a pair of USB pins of a plurality of USB pins to facilitate the wired communication session based on a type of the USB cable.

5. The method of claim 1, comprising adjusting the second data stream based on an offset associated with a time of logic or circuitry of the bridge device performing an action.

6. The method of claim 1, comprising:
generating, via the processing circuitry, a third data stream comprising positive non-packetized electrical pulse signals based on the first data stream; and
transmitting, via the processing circuitry, the third data stream to a second downstream device, wherein the third data stream is configured to enable the second downstream device to synchronize to the host device.

7. The method of claim 6, wherein the first data stream and the third data stream do not comprise negative non-packetized electrical pulse signals.

8. The method of claim 1, comprising transmitting, via the processing circuitry, a third data stream comprising non-packetized positive electrical pulse signals to the host device via the wired communication session, wherein the third data stream is configured to enable the host device to synchronize to the bridge device.

9. An electronic device comprising:
a transmitter; and
processing circuitry coupled to the transmitter, the processing circuitry being configured to:
establish a wired communication session with a transmitting device;
establish a communication session with a plurality of downstream devices;
receive a first data stream from the transmitting device via the wired communication session, wherein the first data stream comprises non-packetized electrical pulses;
generate a second data stream comprising non-packetized electrical pulses based on the first data stream;
cause the transmitter to transmit the second data stream to a first downstream device of the plurality of downstream devices, wherein the second data stream is configured to enable the first downstream device to synchronize to the transmitting device;
generate a third data stream comprising non-packetized electrical pulses based on the first data stream; and
cause the transmitter to transmit the third data stream to a second downstream device of the plurality of downstream devices, wherein the third data stream is configured to enable the second downstream device to synchronize to the transmitting device.

10. The electronic device of claim 9, wherein the second data stream comprises positive and negative non-packetized electrical pulses, and the third data stream comprises positive and no negative non-packetized electrical pulses.

11. The electronic device of claim 9, wherein the communication session between the electronic device and the first downstream device or the second downstream device comprises a wireless communication session.

12. The electronic device of claim 9, wherein the processing circuitry is configured to receive a fourth a data stream comprising non-packetized electrical pulses from the first downstream device or the second downstream device.

13. The electronic device of claim 12, wherein the processing circuitry is configured to:
generate a fifth data stream comprising non-packetized electrical pulses based on the fourth data stream; and
cause the transmitter to transmit the fifth data stream to the transmitting device, wherein the fifth data stream is configured to enable the transmitting device to synchronize to the first downstream device or the second downstream device.

14. The electronic device of claim 9, comprising logic or circuitry, wherein the logic or circuitry comprises a camera, a speaker, a lighting device, a display, or inertial measurement unit hardware, and wherein the processing circuitry is configured to transmit the first data stream to the logic or circuitry to cause the logic or circuitry to perform an action.

15. An electronic device comprising:
an input/output (I/O) interface; and
processing circuitry coupled to the IO interface, the processing circuitry configured to:
cause the electronic device to receive, via the I/O interface, a first data stream comprising positive non-packetized electrical pulse signals from a first device;
generate a second data stream comprising non-packetized electrical pulse signals based on the first data stream;
transmit the second data stream to a second device, wherein the second data stream is configured to enable the second device to synchronize to the first device;
generate a third data stream comprising non-packetized electrical pulse signals based on the first data stream; and
transmit the third data stream to a third device, wherein the third data stream is configured to enable the third device to synchronize to the first device.

16. The electronic device of claim 15, wherein the second data stream comprises different frequencies of non-packetized electrical pulse signals than the third data stream.

17. The electronic device of claim 15, wherein the processing circuitry is configured to transmit the second data stream to the second device and the third data stream to the third device concurrently.

18. The electronic device of claim 15, wherein the I/O interface comprises a port controller configured to communicatively couple to the first device based on a Universal Serial Bus (USB) Type-C communication protocol.

19. The electronic device of claim 15, comprising logic or circuitry, wherein the processing circuitry is configured to synchronize an operation of the logic or circuitry to the first device based on the first data stream.

20. The electronic device of claim 19, wherein the processing circuitry is configured to generate the second data stream and the third data stream based on the first data stream and an offset associated with the logic or circuitry.
